(19) United States
(12) Patent Application Publication
(10) Pub. No.: US 2008/0173769 A1
(43) Pub. Date: Jul. 24, 2008

(54) Stabilized tilt rotor aircraft

(76) Inventor: George Philip Tharisayi, Berkeley, CA (US)

Correspondence Address: GEORGE PHILIP THARISAYI, 693 HILLDALE AVE, BERKLEY, CA, 94708, US

(21) Appl. No.: 12/008,819

(22) Filed: Jan. 14, 2008

Related U.S. Application Data
(60) Provisional application No. 60/881,428, filed on Jan. 22, 2007.

(51) Int. Cl. B64C 27/22

(52) U.S. Cl. 244/7 R

(57) ABSTRACT

The purpose of this invention is to design and construct Stabilized Tilt Rotor Aircraft (STRA). Stabilized Tilt Rotor Aircraft is a subsonic aircraft with tilt rotors assisted by tilting louvers and tail rotors powered by the battery charged by the rotor engines. During take off and landing when operational speeds are below stall, stability is provided by the tilting rotors, the tilting louvers and the battery powered tail rotors.

This non-provisional utility patent application claims the benefit of provisional patent No. 60/881,428 filed on Jan. 22, 2007.

### BACKGROUND OF THE INVENTION

The purpose of this invention is to improve the stability of tilt rotor aircraft by the stability enhancement features of Stabilized Tilt Rotor Aircraft (STRA). Stabilized Tilt Rotor Aircraft is a subsonic aircraft with tilt rotors assisted by tilting louvers and tail rotors powered by the battery charged by the rotor engines. During take off and landing when operational speeds are below stall, stability is provided by the tilting rotors, the tilting louvers and the battery powered tail rotors. STRA will be able to take off from land or water vertically or after a gliding on water. This aircraft will be able to vertical land or short land into land or water. In case of emergency, this aircraft will be able to perform vertical landing into land or water by means of parachutes with further assistance from the tilt rotors and rotors in the tail. The tilt rotors are powered by diesel, gasoline, jet fuel or liquefied natural gas. The tail rotors are powered by an on board rechargeable electric battery.

### BRIEF SUMMARY OF THE INVENTION

Stabilized Tilt Rotor Aircraft (STRA) can be made of metals, glass, fiber glass, plastics or any combination thereof. The propulsion assemblies consist of piston engines with propeller or turbo prop engines powered by diesel, gasoline, jet fuel or liquefied natural gas and will have variable pitch blades designed by means of known art. The tilt rotors can rotate in unison from vertical to a fully forward or any where in between. Two sets tilting louvers one upper and one lower in each of the two tilt rotors provide operational stability in low speeds below stall speed of the aircraft. Stabilized Tilt Rotor Aircraft is also assisted by tail rotors powered by the rechargeable battery. STRA provides stability in the three axes namely X, Y & Z and for moments about the three axes. The electric battery is charged by the tilt rotor engines and powers the rotors in the vertical and horizontal tail.

### BRIEF DESCRIPTION OF THE SEVERAL VIEWS OF THE DRAWING

FIG. 1.

FIG. 1 is the elevation view of the aircraft.

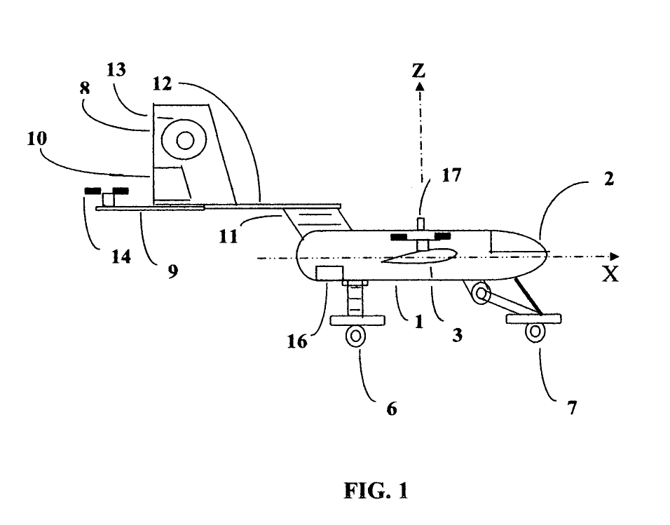

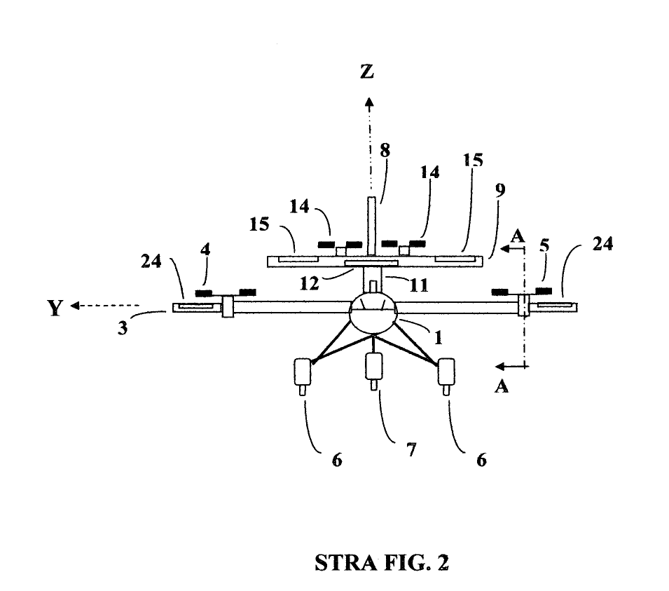

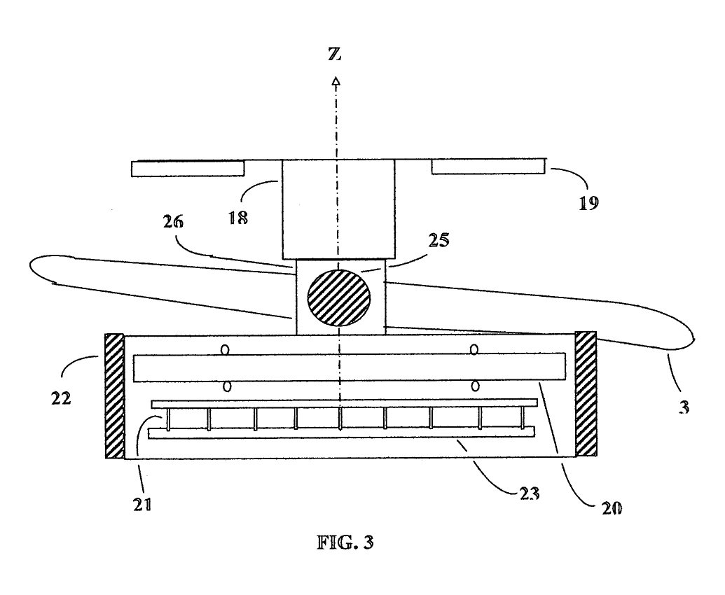

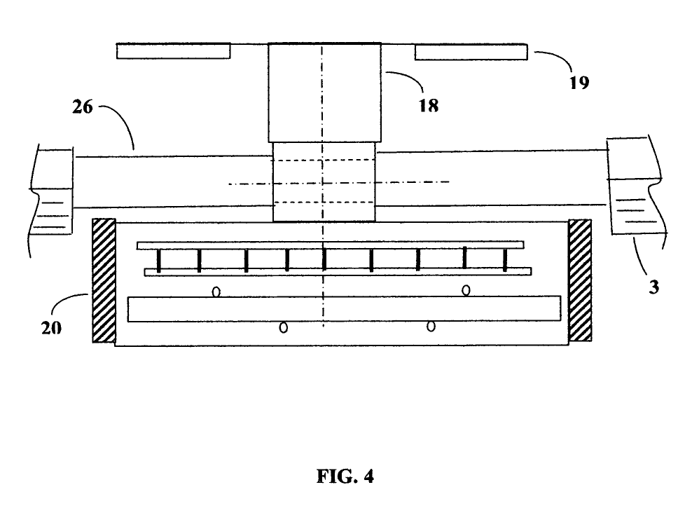

The X is the axis pointing forward and Z is the axis pointing upward. (1) is the fuselage of the aircraft. (2) is the cockpit and (3) is the main wing. (6) is a pair of rear landing assembly consisting of one wheel or a plurality of wheels and one float each or a plurality of floats. (7) is a front landing assembly consisting of one wheel or a plurality of wheels and one float or a plurality of floats. (8) is the vertical tail of the aircraft and (9) is the horizontal tail. (10) is the rudder. (11) and (12) are structural members that connect tail to fuselage (1). (13) is the rotor in the vertical tail. (14) is a pair of rotors on the horizontal tail. (16) is a rechargeable electric battery. (17) is a parachute.

FIG. 2

FIG. 2 is the front view of the aircraft.

The axis Y is perpendicular to both X axis and Z axis and pointing horizontally to the right of the aircraft, along the centerline of the main wing (3). (1) is the fuselage of the aircraft. (3) is the main wing. (4) is the tilt rotor assembly attached to the right side of the main wing (3) and (5) is the tilt rotor assembly attached to the left side of the main wing (3). (6) is a pair of rear landing assembly consisting of one wheel or a plurality of wheels and one float or a plurality of floats. (7) a front landing assembly consisting of one wheel or a plurality of wheels and one float each or a plurality of floats. (8) is the vertical tail of the aircraft and (9) is the horizontal tail. (11) and (12) are structural members that connect tail to fuselage (1). (14) is a pair of rotors in the horizontal tail. (15) is a pair of elevators. (24) is pair of ailerons.

FIG. 3

FIG. 3 is the sectional view A-A of the tilt rotor assembly (5) and consists of parts shown in this view.

(18) is an engine assembly with an electric starter and an alternator to charge the electric battery (16). (19) is a propeller assembly with a plurality of propellers with variable pitch. (25) is a shaft about which the tilt rotor assembly can tilt. (26) is an assembly supporting shaft (25) and is connected to main wing (3). (20) is a set of upper louvers parallel to X-Axis. (21) is a set of lower louvers parallel to Y-Axis. (22) is a circular structure attached to (26) which contain the upper and lower louvers, louver rods and actuators for the louver rods. (23) are a plurality of rods at the top and bottom of the upper louvers (20) and lower louvers (21).

FIG. 4

FIG. 4 is the front view of the rotor assembly (4) and (5).

(18) is the engine assembly. (20) is the circular structure containing upper louvers (20), lower louvers (21), louver rods (23) and louver rod actuators. (26) is an assembly supporting shaft (25) and is connected to main wing (3).

### DETAILED DESCRIPTION OF THE INVENTION

Stabilized Tilt Rotor Aircraft can be made of metals, glass, fiber glass, plastics or any combination thereof. The tilt rotor assemblies (4) and (5) are identical and consist of piston engines with propeller or turbo prop engines and will have variable pitch blades designed by means of known art. The engines are powered by gasoline, diesel, jet fuel or liquefied natural gas. Stabilized Tilt Rotor Aircraft is a vertical or short take off and landing subsonic aircraft. The tilt rotors can rotate in unison from the Z axis forward to the X axis, backward from the X axis to the Z axis and can be stationary at any angle in between X and Z. The lower louvers (21) can tilt up to 60 degree backward or 60 degrees forward to Z axis or can be stationary any where in between. The upper louvers (20) can tilt up to 60 degrees to the left or 60 degrees to the right of Z axis or can be stationary any where in between. The upper louvers of tilt rotors (4) and (5) can tilt in unison or independently. The lower louvers of tilt rotors (4) and (5) can tilt in unison or independently. The circular structure (20) contains upper louvers (20), lower louvers (21), louver rods (23) and louver rod actuators.

The electric battery (16) is charged by the engines (18) of tilt rotors (4) and (5) when the aircraft is stationery or when the aircraft is in flight. The rotor (13) and the rotors (14) are powered by electric battery (16). The tilt rotors (13) and (14) will have variable positive pitch and variable negative pitch designed and constructed by means of known art. The control systems and all components and instruments will be designed and constructed by means of known art and designed and programmed to achieve all performance features of the Aircraft.

In the vertical take off mode, the tilt rotors are pointed upward along the Z axis. When a G force greater than 1.0 is applied by the combined thrust from the two tilt rotors (4) and (5), the Stabilized Tilt Rotor Aircraft (STRA) begins to lift off. In order to assure stability, the STRA has to have stability in the X, Y and Z axis and also have to have control on moments about the three axes. The control in the Z axis is provided by the rotor thrust which is controlled by power and the propeller pitch of (19). The STRA can provide control along the X axis by tilting of the lower louvers (21), without having to tilt the rotor itself forward or backwards. The control in the Y axis is provided by tilting of the upper louvers (20). The control of moment about X axis is provided by thrust difference between rotors (4) and (5). The control of the moment about the Y axis is provided by rotors (14). The control of the moment about the Z axis is provided by rotor (13). STRA uses this method alone for stability in vertical take off mode. STRA uses this method partially in other flight conditions when the forward speed is below stall. For short take off, though the forward movement can be provided by tilting of the lower louvers (21) backwards, substantial forward movement is provided by tilting the rotors (4) and (5) forward in unison and holding the rotors at a desired angle between Z and X axes. In the preferred embodiment, the initial forward tilt will be closer to the Z axis than the X axis. When the aircraft has no forward speed, all of the control of the aircraft is accomplished by the same procedure as for the case when the tilt rotor is in full upward position, along Z axis. When STRA has forward speed, some of the stability is obtained from the main wing and control surfaces of elevators (15), rudder (10) and ailerons (24). Once STRA reaches a forward speed above stall, the rotors (4) and (5) tilts fully forward in line with the X axis or closer to the X-axis than the Z axis and all of the control is obtained from the main wing (3) and control surfaces of elevators (15), rudder (10) and ailerons (24). This describes STRA in normal flight.

For short landing, the STRA slows by reducing power of the tilt rotors (4) and (5) they tilt in unison to an upward position closer to the Z axis than the X axis, before the aircraft reaches stall speed. The STRA further reduces speed below stall speed and part of the lift will be provided by the tilt rotors. STRA then performs a short landing.

For vertical landing, the STRA slows by reducing power and rotors (4) and (5) tilts to an upward position closer to the Z axis than the X axis, before the aircraft reaches stall speed. The STRA further reduces speed below stall speed by flying into a significantly nose up flight by operating elevators (15) and rotors (14). In this flying mode, the lift of rotors (4) and (5) are partially used for reducing the forward speed. Before the STRA reaches zero forward speed, the aircraft is moved into a level poison by operating rotors (14) and rotors (4) and (5) are tilted to vertical position, in line with axis Z. Further gradual reduction in power of tilt rotors (4) and (5) gradually descends the aircraft for vertical landing.

I claim:

1. A Stabilized Tilt Rotor Aircraft (STRA), comprising of a fuselage, a main wing, a horizontal tail, a vertical tail, a cockpit, front and back landing gears, a rudder, pair of elevators, pair of ailerons, two tilt rotors mounted on the main wing, one rotor to the left and the second rotor to the right of the fuselage of the aircraft, each tilt rotor having variable pitch and having one set of upper louvers consisting of one or more louvers parallel to the fuselage and each tilt rotor having one set of lower louvers consisting of one or more louvers parallel to main wing.

2. The aircraft of claim 1, further comprising: one or a plurality of rotors in the vertical tail with variable positive and negative pitches, one or a plurality of rotors in the horizontal tail with variable positive and negative pitches, the rotors being powered by a rechargeable electric battery rechargeable by one or both tilt rotor engines.

3. The aircraft of claim 1 and 2, further comprising: a parachute which can be deployed for emergency landing, assisted by available tilt rotors, rudder, elevators, ailerons and rotors in the vertical tail and in the horizontal tail.

4. The aircraft of claim 1 and 2, wherein stability is provided along in the three axes, along X, Y and Z axis (along the centerline of the fuselage, along the centerline of the wings and along the vertical axis, respectively), in vertical lift operation and in all operations when aircraft speed is lower than the aircraft stall speed, wherein the rotor or rotors are in vertical position or in a tilted position from the vertical position.

5. The aircraft of claim 1 and 2, wherein moment stability is provided about the three axes, namely X, Y and Z axes (the X axis being along the centerline of the fuselage, the Y-axis being along the centerline of the wings and the Z-axis being along the vertical axis), in vertical lift operation and in all operations when aircraft speed is lower than the aircraft stall speed, wherein the rotor or rotors are in vertical position or in a tilted position from the vertical position.

6. The aircraft of claim 1 and 2, wherein the aircraft is capable of forward and reverse movements without tilting the tilt rotor or tilt rotors from the vertical position, by operation of the lower louvers, once the aircraft has lifted off from the ground.

7. The aircraft of claim 1 and 2, wherein the aircraft is capable of movements to the left or to the right of the aircraft along the main wing by operation of the lower louvers, once the aircraft has lifted off from the ground.

8. The aircraft of claim 1 and 2, wherein the aircraft is capable of a short take off by the operation of the lower louvers independently or in combination with forward tilting o of the tilt rotors and propelling the aircraft to a speed lower than the aircraft stall speed on land or water followed by lift off from water or ground and further tilting of the tilt rotors to reach a speed above stall for normal operation.

9. The aircraft of claim 1 and 2, wherein the aircraft is capable of a short take off by the operation of the lower louvers independently or in combination with forward tilting o of the tilt rotors and propelling the aircraft to a speed higher than the aircraft stall speed on land or water followed by lift off from water or ground and further tilting of the tilt rotors to reach a speed above stall for normal operation.

10. The aircraft of claim 1 and 2, wherein the aircraft is capable of normal operation above stall speed the safety of operation being enhanced by upper and lower louvers and tail rotors.
